(19) United States
(12) Patent Application Publication
(10) Pub. No.: US 2006/0091134 A1
(43) Pub. Date: May 4, 2006

(54) Method and apparatus for heating refractory oxides

(76) Inventor: Mark Tarnawski, Fairfield (AU)

Correspondence Address: Duane Morris, Suite 700, 1667 K Street NW, Washington, DC, 20006, US

(21) Appl. No.: 10/534,886

(22) PCT Filed: Nov. 10, 2003
(86) PCT No.: PCT/AU03/01488

§ 371 Date: Nov. 29, 2005

(30) Foreign Application Priority Data
Nov. 15, 2002 (AU) 2002952716
Dec. 13, 2002 (AU) 2002953318

(51) Int. Cl. H05B 6/02

(52) U.S. Cl. 219/601

(57) ABSTRACT

A method of heating a refractory oxide material comprising applying a high frequency electric field to heat the refractory oxide material and applying a magnetic field to heat the refractory oxide material. The high frequency electric field substantially heating the refractory oxide material to a temperature range at which the refractory oxide material undergoes a transition in electrical resistivity from an insulator to a conductor. The magnetic field inductively heats the refractory oxide material during and/or after the transition.

### TECHNICAL FIELD

The present invention relates to a method and apparatus for heating refractory oxides, and more particularly to a method and apparatus for heating refractory oxides without degrading their purity.

### BACKGROUND

Refractory oxides are insulators at low temperatures but become conductors when their temperature is raised above a certain temperature.

It is known to heat and melt refractory oxides in a process known as “skull” melting. In this process a refractory, i.e., a high-melting material, in the form of a solid is contained in a water-cooled crucible-like structure and it is then heated by direct high frequency induction heating. By cooling the outer surface of the material mass, a sintered shell or “skull” of the material is formed to contain an internal molten mass. Thus the melt, which may be used for casting, recrystallization or crystal formation, is free from contamination. Moreover, this process makes it possible to contain stable, uncontaminated melts of even the most refractory materials for which no crucibles are known to exist. Thus the previously severe, if not insoluble, problems of containment and contamination have been reduced.

The ability to synthesize refractory semiconductors and to crystallize refractory oxides such as Y₂O₃ (m.p. 2376° C.), ZrO₂ (m.p. 2690° C.), La₂O₃ (m.p. 2300° C.) and HfO₂ (m.p. 2790° C.), as well as mixed oxides such as LaAlO₃ (m.p. 2100° C.), CaZrO₃ (m.p. 2345° C.) and the like, means that it is possible to provide such materials as unique laser crystals, refractory optical elements and melt-cast ceramics. U.S. Pat. No. 4,049,384 (Wenckus et al.) discloses a cold crucible system which can be used for such a purpose.

Skull melting technology also has other applications such as the safe containment of nuclear wastes such as plutonium and uranium oxide. For example, in one known system plutonium scrap and residue is converted to borosilicate glass using a skull melting process.

Skull melting using Radio Frequency (RF) induction heating can be used to melt oxides of the most refractory nature (eg. thoria, zirconia), because the frequency is low enough to produce circulating eddy currents in the load material when it is molten. The frequency used is typically in the range of 0.5-13 Mhz, and preferably greater than 3.8 Mhz. The eddy currents act against the resistance of the material and heat is generated by I²R Joule heating. Although the upper temperature limit is determined only by the amount of input power available and the thermodynamic characteristics of the crucible, skull melting has an intrinsic low temperature limitation.

Skull melters cannot be used below the insulator to conductor transition temperature of the oxide without the use of an initiator. The initiator is typically a metal disc or fragments of metal present in the composition of a compound or graphite. The initiator raises the temperature of a localized portion of the load in the crucible. At a certain temperature, the material to be melted becomes conductive enough for “eddy current” induction heating to occur in the material itself.

Two main disadvantages exist with skull melting of this type. Firstly, where an initiator is used, an impurity is introduced into the refractory oxide to be melted. Secondly, if the temperature of the melt falls below a certain temperature, the load may fail to couple with the RF and will rapidly cool down. Although raising the temperature is relatively easy, controlled cooling of the melt is practically difficult.

In other processes it is known to heat oxides by microwave heating at very high frequencies such as 915 MHz and 2450 MHz, the latter being the most common frequency used for industrial and home microwave ovens. Certain oxides require preheating to 300° C.-500° C. with a susceptor (reactive agent) such as silicon carbide, graphite or alumina to initiate the microwave heating. U.S. Pat. No. 4,219,361 (Sutton et al.) discloses a method of improving the susceptibility of an oxide to microwave heating.

A disadvantage of microwave heating certain oxides is that once they begin to absorb microwave energy directly, their microwave susceptibility increases exponentially. This can result in an uncontrollable temperature rise referred to as “thermal runaway”. This can lead to cracking, poor grain size, equipment damage, and varying degrees of porosity. A further problem is that the penetration of microwaves is limited to a depth in the order of tens of microns because the frequency is very high. Heating electrically large conductors with microwaves creates an extremely thin heated surface layer, and the interior remains completely cold. Eventually, the reflected power causes arcing and may damage the equipment. As such, the prior art relating to microwave heating of oxides is related principally with sintering rather than melting.

The present invention seeks to ameliorate the heating of refractory oxides by at least substantially overcoming the disadvantages associated with the abovementioned processes.

### SUMMARY OF THE INVENTION

According to a first aspect the present invention consists of a method of heating a refractory oxide material, said method comprising applying a high frequency electric field to heat said refractory oxide material and applying a magnetic field to heat said refractory oxide material, said high frequency electric field substantially heating said refractory oxide material to a temperature range at which said refractory oxide material undergoes a transition in electrical resistivity from an insulator to a conductor, and the magnetic field inductively heats said refractory oxide material during and/or after said transition.

Preferably said high frequency electric field and said magnetic field is imparted to said refractory oxide material via a resonant structure.

Preferably the frequency imparted via the resonant structure is carried out within a first range of frequencies at which heating is substantially carried out by the electric field, and then subsequently lowered to a second range of frequencies at which heating is substantially carried out by the magnetic field.

Preferably said first range of frequencies is in the range of 13 MHz-42 MHz.

Preferably said second range of frequencies is in the range of 0.5 MHz-13 MHz.

Preferably in one embodiment said refractory oxide material is held within a container and said high frequency electric field is substantially imparted to said refractory oxide material by two spaced apart plates connected to an electric circuit, and said magnetic field is imparted by an RF coil surrounding said container.

Preferably in another embodiment said refractory oxide material is held within a non-faraday container and both said high frequency electric field and said magnetic field is imparted by an RF coil surrounding said non-faraday container.

In one embodiment said method is preferably used in the manufacture of a synthetic gemstone.

In another embodiment said method is preferably used to vitrify a hazardous or other waste material.

According to a second aspect the present invention consists in a crucible apparatus for heating a refractory oxide material, said apparatus comprising a means for supporting said refractory oxide material, a means for imparting a high frequency electric field to said refractory oxide material and a means for imparting a magnetic field to said refractory oxide material.

Preferably said crucible apparatus comprises a resonant structure.

In one embodiment said crucible apparatus preferably comprises a container adapted to hold said refractory oxide material, and said means for imparting a magnetic field to said refractory oxide material is an RF coil surrounding said container.

Preferably said crucible apparatus is connected to a variable frequency generator.

Preferably said variable frequency generator is adapted to impart a frequency in the range 0.5 MHz-42 MHz.

Preferably said means for imparting a high frequency electric field includes two spaced apart plates connected to an electric circuit.

Preferably the capacitance between said two spaced apart plates may be variably adjusted.

Preferably at least one of said two spaced apart plates is water-cooled.

Preferably said crucible apparatus comprising a sensing means for sensing the temperature of said refractory oxide material, said sensing means operably connected to a control means which varies the frequency imparted by said variable frequency generator relative to the sensed temperature.

Preferably said means for imparting a magnetic field to said refractory oxide material is adapted to substantially heat same at a frequency in the range 0.5 MHz-13 MHz.

Preferably said means for imparting a electric field to said refractory oxide material is adapted to substantially heat same at a frequency in the range 13 MHz-42 MHz.

In one embodiment said crucible apparatus preferably comprises a non-faraday container adapted to hold said refractory oxide material, and said means for imparting an electric field to said refractory oxide material is an RF coil surrounding said non-faraday container, and said means for imparting a magnetic field to said refractory oxide material is said RF coil.

### BRIEF DESCRIPTION OF THE DRAWINGS

The invention will now be described with reference to drawings in which:

FIG. 1 is a schematic elevational view of a crucible apparatus according to a first embodiment of the present invention.

FIG. 2 is a schematic circuit diagram of the crucible apparatus shown in FIG. 1.

### BEST MODE OF CARRYING OUT INVENTION

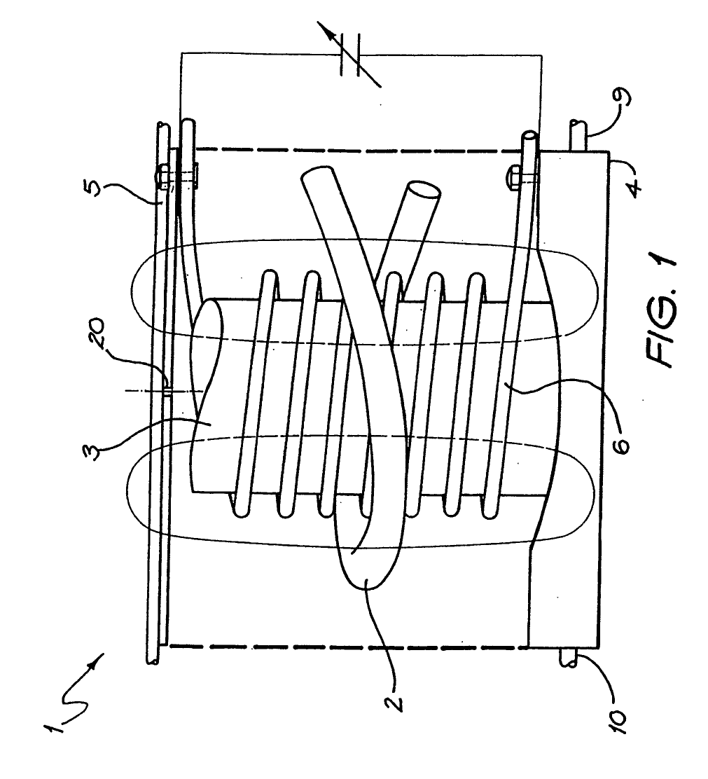

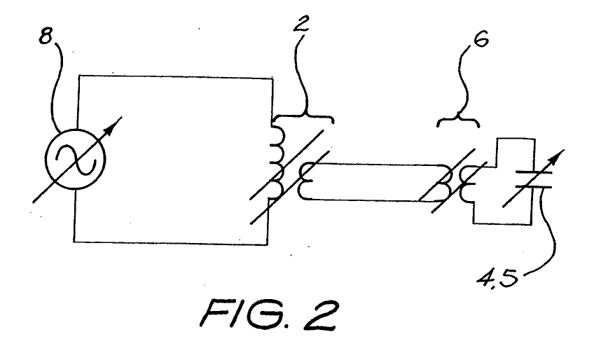

FIGS. 1 and 2 depict a crucible 1 for the heating and melting of refractory oxides. Crucible 1 is mounted on an insulating stand (not shown) made of a material such as Teflon and high density polyethylene to isolate the crucible 1 from the ground.

Crucible 1 comprises a container 3, seated on a base plate 4 and covered by a top plate 5.

A conventional water cooled RF coil 6 surrounds container 3 and is adapted to inductively heat an oxide placed in container 1 by imposing a magnetic field thereto, at a frequency typically in the range of 0.5 MHz-13 MHz.

The base plate 4 and top plate 5 form part of an electric circuit in which these plates act as capacitor plates for imparting an electric field on the container 3 and its contents. The base plate 4 is dished-shaped and is water cooled. Cooling water is able to enter base plate 4 via inlet 9 and exits through outlet 10. The dished configuration of base plate 4 allows for a molten sample within container 3 to be cooled. Top plate 5 is also water cooled and has a hole 20 therein.

A further excitor coil 2 surrounds RF coil 6 and is operably connected to a variable frequency generator 8, not shown in FIG. 1.

In a simplified description of this embodiment the base plate 4 and top plate 5 are used in the form of a capacitor, and are adapted to impart heating to the refractory oxide material placed within container 1 at a frequency typically in the range of 13 MHz to 40 MHz.

Initially, the electric field provides a dielectric heating process by creating heating losses in the oxide, Which initially is a non-conductor (insulator), by the processes of polarisation and relaxation and dipole movement. The alternating (oscillating) electric field occurs between top plate 5 and base plate 4 as they are connected to the frequency generator 8, which is an electrical high frequency source. The alternating electric field polarises atoms, molecules, charge carriers and mobile species in the refractory oxide material, firstly in one direction and then in the other. Any difference in the energy required to do this, in a given direction, is observed as heat. The capacity of an “insulator”, (in this case the refractory oxide material), to heat in this fashion, is referred to as its “loss factor” or loss tangent. The higher the loss factor the better it heats.

As the temperature in the refractory oxide material rises, it will approach a temperature range at which the refractory oxide material will undergo a transition in electrical resistivity from an insulator to a conductor. At this stage the refractory oxide will continue to be heated by the inductive heat generated by the magnetic field imported by RF coil 6 in the conventional manner.

In order to achieve the combination of both electric and magnetic fields to heat a refractory oxide material placed in container 3, it is necessary to vary the frequency being applied to the crucible 1, which is a resonant structure. FIG. 2 depicts schematically the RF coil 6, bottom plate 4 and top plate 5 connected to variable frequency generator 8. Preferably the frequency of the generator is adapted to be varied between 0.5 MHz to 40 MHz.

In trials carried out ZrO₂, CeO₂, Al₂O₃, SiO₂ and TiO₂ in powdered form or mixtures or compounds containing these were heated. In order to heat the sample the electric field and magnetic field are simultaneously applied with the frequency of the RF generator 8 preferably greater than 25 MHz, and as high as about 40 MHz. In this frequency range the electric field is sufficient to cause the heating of the refractory oxide in its non-conductor (insulator) state. As the temperature of the sample increases and reaches the transition stage, the frequency may be lowered to about 10 MHz, where both the electric field and the magnetic fields are acting to heat the refractory oxide material. As the temperature continues to rise and the properties of the refractory oxide material alter to that substantially of a conductor, the frequency generator 8 is varied to lower the frequency significantly to as low as 0.5 MHz and the refractory oxide material continues to be heated by the inductive process. As can be seen from the above, higher frequencies favour electric field heating, whilst lower frequencies favour induction heating.

The advantages of the above referenced crucible apparatus and method is that whilst prior art microwave devices have been fixed at a high frequency say of about 2450 MHz which favours dielectric heating over induction, it has been found that conductors become complete reflectors of magnetic fields at higher frequencies. As such, by providing a start up frequency in the range of about 25-40 MHz to impart heating by an electric field, the frequency is then variably lowered to a range of about 0.5-4 MHz which is the range in which induction heating is very efficient.

When the method and apparatus as described above is used, it has been found that refractory oxides such as TiO₂, CeO₂, and ZrO₂ will spontaneously initiate and therefore they require no initiator. However, for materials that have too low a loss factor (such as Al₂O₃ and SiO₂), a molybdenum or tungsten rod can be momentarily placed in hole 20 in the top plate 5 to initiate an electrical plasma discharge which creates a molten discharge tube in the centre of the sample. The metallic rod can be removed immediately following start up, and then does not contaminate the sample.

The arrangement of the base plate 4 and top plate 5 with coil 6 in between maximises the relative effects of the electric and magnetic fields generated.

Whilst in the most simplified form the frequency may be varied by manual adjustment it should be understood that in another not shown embodiment the crucible may comprise a sensing means for sensing the temperature of said refractory oxide material, the sensing means operably connected to a control means such as an electronic control unit (ECU) which varies the frequency imparted by said variable frequency generator relative to the sensed temperature.

An advantage of the present invention over the prior art skull melters, is that when heating of the refractory oxide material held within container 3 is inadvertently interrupted or ceased, it can readily be restarted.

In a further not shown embodiment, an apparatus in accordance with the present invention comprises an RF coil similar to coil 6 of the earlier described embodiment, connected to a variable frequency generator also similar to the variable frequency generator 8 of the earlier described embodiment. However, in this embodiment the RF coil surrounds a “non-faraday container” ie. either a non-metallic container such as a ceramic container, or some other container that doesn't screen out electric fields. In this specification a “non-faraday container” is defined as a container made of a material or of a configuration that does not interfere with RF radiation passing therethrough. A refractory oxide material when placed in such a non-faraday container, will heat in dielectric fashion when the frequency is high ie. 13-42 MHz. This as a result of there being a significant electric field around such a coil at such high frequencies. In use a refractory oxide material placed in the non-faraday container may initially be heated dielectrically by imposing a high frequency in say a range of 13-42 MHz. Once start-up melting has occurred, the frequency can be lowered, say to within the range of 0.5-13 MHz, thereby primarily heating the refractory oxide material by the magnetic field inductive effect.

Like that of the earlier embodiment, this not shown apparatus may also include a sensing means for sensing the temperature of the material, which may vary the frequency imparted by said variable frequency generator relative to the sensing temperatures.

There are various commercial industrial applications where it is desirable to heat refractory oxides. One such application is the manufacture of synthetic gemstones such as, ruby, sapphire, cubic zirconia etc, all of which can be manufactured by the method and apparatus of the present invention.

Furthermore, the method and apparatus of the present invention can be used in neutralising hazardous waste, such as radioactive waste that comprises in at least part of refractory oxide materials. Such hazardous waste includes asbestos fibres/cement, which can be heated to become a vitrified (glass) form, for ease of handling and disposal. It should be understood that the present invention may also, be used for the vitrification of various other waste materials such as fly ash, sewage sludge, old batteries etc. Such vitrification may allow for the heated materials to be formed into solid blocks for disposal, or to be recycled for other purposes.

The term “comprising” as used herein is used in the inclusive sense of “including” or “having” and not in the exclusive sense of “consisting only of”.

1. A method of heating a refractory oxide material, said method comprising applying a high frequency electric field to heat said refractory oxide material and applying a magnetic field to heat said refractory oxide material, said high frequency electric field substantially heating said refractory oxide material to a temperature range at which said refractory oxide material undergoes a transition in electrical resistivity from an insulator to a conductor, and the magnetic field inductively heats said refractory oxide material during and/or after said transition.

2. A method as claimed in claim 1, wherein said high frequency electric field and said magnetic field is imparted to said refractory oxide material via a resonant structure.

3. A method as claimed in claim 2, wherein the frequency imparted via the resonant structure is carried out within a first range of frequencies at which heating is substantially carried out by the electric field, and then subsequently lowered to a second range of frequencies at which heating is substantially carried out by the magnetic field.

4. A method as claimed in claim 3, wherein said first range of frequencies is in the range of 13 MHz-42 MHz.

5. A method as claimed in claim 3, wherein said second range of frequencies is in the range of 0.5 MHz-13 MHz.

6. A method of heating a refractory oxide material as claimed in claim 1, wherein said refractory oxide material is held within a container and said high frequency electric field is substantially imparted to said refractory oxide material by two spaced apart plates connected to an electric circuit, and said magnetic field is imparted by an RF coil surrounding said container.

7. A method of heating a refractory oxide material as claimed in claim 1, wherein said refractory oxide material is held with a non-faraday container and both said high frequency electric field and said magnetic field is imparted by an RF coil surrounding said non-faraday container.

8. A method of heating a refractory oxide material as claimed in claim 1, wherein said method is used in the manufacture of a synthetic gemstone.

9. A method of heating a refractory oxide material as claimed in claim 1, wherein said method is used to vitrify a hazardous or other waste material.

10. A crucible apparatus for heating a refractory oxide material, said apparatus comprising a means for supporting said refractory oxide material, a means for imparting a high frequency electric field to said refractory oxide material and a means for imparting a magnetic field to said refractory oxide material.

11. A crucible apparatus as claimed in claim 10, wherein said crucible comprises a resonant structure.

12. A crucible apparatus as claimed in claim 10, comprising a container adapted to hold said refractory oxide material, and said means for imparting a magnetic field to said refractory oxide material is an RF coil surrounding said container.

13. A crucible apparatus as claimed in claim 12, wherein said crucible is connected to a variable frequency generator.

14. A crucible apparatus as claimed in claim 13, wherein said variable frequency generator is adapted to impart a frequency in the range 0.5 MHz-42 MHz.

15. A crucible apparatus as claimed in claim 10, wherein said means for imparting a high frequency electric field includes two spaced apart plates connected to an electric circuit.

16. A crucible apparatus as claimed in claim 15, wherein the capacitance between said two spaced apart plates may be variably adjusted.

17. A crucible apparatus as claimed in claim 15, wherein at least one of said two spaced apart plates is water-cooled.

18. A crucible apparatus as claimed in claim 13 comprising a sensing means for sensing the temperature of said refractory oxide material, said sensing means operably connected to a control means which varies the frequency imparted by said variable frequency generator relative to the sensed temperature.

19. A crucible apparatus as claimed in claim 10, wherein said means for imparting a magnetic field to said refractory oxide material is adapted to substantially heat same at a frequency in the range 0.5 MHz-13 MHz.

20. A crucible apparatus as claimed in claim 10, wherein said means for imparting a electric field to said refractory oxide material is adapted to substantially heat same at a frequency in the range 13 MHz-42 MHz.

21. A crucible apparatus as claimed in claim 10, wherein said crucible comprises a non-faraday container adapted to hold said refractory oxide material, and said means for imparting an electric field to said refractory oxide material is an RF coil surrounding said non-faraday container, and said means for imparting a magnetic field to said refractory oxide material is said RF coil.
